(19) United States
(12) Patent Application Publication
(10) Pub. No.: US 2003/0129389 A1
(43) Pub. Date: Jul. 10, 2003

(54) Cover tape for the electronic part conveyance, process for its production and electronic part conveying member

(75) Inventors: Hiroki Ichikawa, Ibaraki-shi (JP); Ichiro Nakano, Ibaraki-shi (JP); Wataru Kakimoto, Ibaraki-shi (JP); Atsushi Tani, Ibaraki-shi (JP)

Correspondence Address: SUGHRUE MION, PLLC, 2100 PENNSYLVANIA AVENUE, N.W., WASHINGTON, DC, 20037, US

(73) Assignee: NITTO DENKO CORPORATION

(21) Appl. No.: 10/323,842

(22) Filed: Dec. 20, 2002

(30) Foreign Application Priority Data
Dec. 20, 2001 (JP) P. 2001-387866

(51) Int. Cl. B32B 15/04; B32B 7/12

(52) U.S. Cl. 428/343; 428/344

(57) ABSTRACT

A cover tape of the invention for the electronic part conveyance includes a substrate having provided thereon a thermally adhesive resin layer with an antistatic layer being provided on the outer side of the substrate or between the substrate and the thermally adhesive resin layer, which is characterized in that thermally adhesive resin layer surface has a contact angle to water of 0.5 to 95° and a surface resistivity of 1.0×10¹³ Ω/square or less. Further, the critical surface tension γc at the surface of the thermally adhesive resin layer may be 2.6×10⁻⁴ to 7.0×10⁻⁴ N/cm.

### BACKGROUND OF THE INVENTION

1. Field of the Invention

This invention relates to an electronic part conveying member for use in conveying chip-type electronic parts or the like before being mounted on a board, a cover tape for use in the electronic part conveying member, and a process for producing the cover tape.

2. Description of the Related Art

As a general manner of conveying chip-type electronic parts such as chip-fixed resistors and laminated ceramic condensers, there has been known a taping reel system using a tape for the electronic part conveyance (electronic part conveying member) In this taping reel system, electronic parts are inserted into electronic part storage pockets provided at definite intervals in the lengthwise direction of a carrier tape made of plastic or paper by means of an automatic parts feeder, the upper side of the carrier tape is heat-sealed with a cover tape comprising a base material (substrate) having provided thereon a thermally adhesive resin layer composed of a thermoplastic adhesive resin to thereby encapsulate the electronic parts, and the thus sealed carrier is wound in a reel form to convey. These steps are generally conducted using a taping machine. And, in a step of manufacturing circuit boards to be conducted in the place where the reel is conveyed, an automatically incorporating system wherein the cover tape is peeled and the inserted electronic parts are automatically suctioned by means of an air nozzle has been mainly employed.

As the functions required for the cover tape to be used in the step of conveying the electronic parts, there are specifically illustrated (i) that adhesive strength for various paper mounts be within a definite range (for example, 0.1 to 0.9 N/mm, preferably 0.3 to 0.4 N/mm), (ii) that a stable peel strength be obtained under an environment of thermal contact bonding and that an appropriate adhesive force be obtained regardless of temperature and kind of adherend, (iii) that an enough heat resistance be obtained to avoid machine troubles due to adhesion or squeeze-out of an adhesive by a heat iron upon stopping a taping machine, (iv) that adhesion or welding to the adhesive layer of the cover tape be avoided after storage of electronic parts, (v) that troubles of electronic parts caused by static electricity generated upon peeling the tape, or mounting failure by projection of the electronic part be avoided, and (vi) that productivity be enhanced by increasing the taping speed.

Additionally, the cover tape is generally produced by, for example, a dry laminating method of laminating a thermally adhesive resin film formed by an extrusion laminating machine, a T-die extruder or an inflation extruder with a base material such as polyethylene terephthalate (PET) via an adhesive.

In relation to recent handling of chip parts such as condensers or resistors and semiconductor electronic parts, various countermeasures have been tried to comply with the request of particularly (v) described above. For example, there has been employed a method of incorporating electrically conductive particles (electrically conductive materials) such as metal powder or metal oxide or an antistatic agent such as a surfactant in the thermally adhesive resin layer constituting the tape. This method, however, involves such problems as that a stable surface resistivity of the tape is not obtained and that visibility of parts is decreased due to reduction in light transmittance.

Also, as another method, there has been conducted a method of coating an antistatic agent or an electrically conductive material on the surface of the thermally adhesive resin layer by means of a kiss roll or the like. However, variation in the peel strength can cause in some cases projection of the electronic parts stored at predetermined positions or cause positional deviation. Further, with some components constituting the thermally adhesive resin layer, adhesion of the surfactant or the electrically conductive material to the thermally adhesive resin is so insufficient that the antistatic agent or the like is transferred to the substrate side, and thus there results a deteriorated antistatic effect, thus such method being disadvantageous from the standpoint of production cost as well.

### SUMMARY OF THE INVENTION

Therefore, an object of the invention is to provide a cover tape for the electronic part conveyance which has the surface properties capable of preventing electrostatic charging upon peeling the cover tape, which shows less variation in the peel strength upon peeling, and which has good peeling properties and an appropriate adhesion, and a process for producing the same.

Another object of the invention is to provide a cover tape for the electronic part conveyance which has an enough high transparency to secure good visibility and an excellent storage stability in addition to the above-mentioned properties, and a process for producing the same.

A further object of the invention is to provide an electronic part conveying member equipped with the cover tape having the excellent performance as mentioned above.

As a result of intensive investigations to attain the above objects, the inventors have found that a tape having definite surface properties can be obtained by subjecting at least one surface of a cover tape to a specific treatment and adjusting the thickness of an antistatic layer, thus troubles with electronic parts caused by static electricity being prevented, and have found that stable peeling properties, suitable adhesive property and a high light transmittance can be obtained by providing a thermally adhesive resin layer of a specific formulation, thus having completed the invention.

That is, the invention provides a cover tape for the electronic part conveyance comprising a substrate having provided thereon a thermally adhesive resin layer with an antistatic layer being provided on the outer side of the substrate (on the opposite side of the substrate to the thermally adhesive resin layer) or between the substrate and the thermally adhesive resin layer, in which the thermally adhesive resin layer has a surface (outer surface) of 0.5 to 95° in contact angle to water and 1.0×10¹³ Ω/square (hereinafter sometimes referred to as Ω/□) or less in surface resistivity. The critical surface tension, γc at the surface of the thermally adhesive resin layer is, for example, 2.6×10⁻⁴ to 7.0×10⁻⁴ N/cm. Further, the contact angle to water at the surface of the opposite surface of the cover tape to the thermally adhesive resin layer may be 0.5 to 70°, and the surface resistivities of the cover tape at its both surfaces may be 1.0×10¹³ Ω/□ or less.

The thermally adhesive resin layer may comprise at least one or more polymers selected from among an olefin copolymer containing carboxyl groups or acyloxy groups within the molecule, an ionomer resin and a block copolymer between an aromatic vinyl compound and a conjugated diene compound, an adhesion-imparting resin in an amount of 1 to 100 parts by weight per 100 parts by weight of the polymer, and an antistatic agent and/or an electrically conductive material in an amount of 0.05 to 50 parts by weight per 100 parts by weight of the polymer.

The thickness of the antistatic layer may be, for example, 0.005 to 5 μm.

Also, peel force of the cover tape after being left for 30 days in an environment of 60° C. and 90% RH in a state of being bonded to a paper mount is, for example, 0.1 to 0.9 N, and the cover tape has a light transmittance of, for example, 80% or more. Further, at least one surface of the cover tape may have been subjected to at least one treatment selected from among a moistening treatment, a steam spray treatment and a treatment of spraying with an aqueous antistatic agent.

The invention also provides a process for producing a cover tape for the electronic part conveyance, which comprises subjecting at least one surface of a laminate comprising a substrate having provided thereon a thermally adhesive resin layer with an antistatic layer being provided on the outer side of the substrate or between the substrate and the heat-bondable resin layer to at least one treatment selected from among a moistening treatment, a steam spray treatment and a treatment of spraying with an aqueous antistatic agent.

Further, the invention provides an electronic part conveying member comprising an electronic part storage member for storing an electronic part and a cover tape for covering the electronic part storage member, wherein the above-mentioned cover tape for the electronic part conveyance described above is used as the cover tape.

### BRIEF DESCRIPTION OF THE DRAWINGS

FIG. 1 is a schematic cross section showing one example of the cover tape of the invention for the electronic part conveyance.

FIG. 2 is a schematic cross section showing another example of the cover tape of the invention for the electronic part conveyance.

Description of the reference numerals used in the drawings is set forth below.

1 Substrate

2 Thermally adhesive resin layer

3 Antistatic layer

4 Base coating layer

5 Interlayer

### DETAILED DESCRIPTION OF THE INVENTION

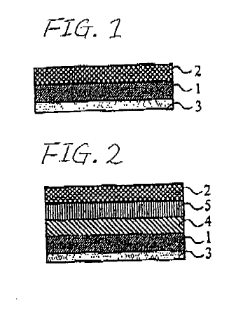

Modes for carrying out the invention are described in detail below by reference to, if necessary, drawings. FIG. 1 is a schematic cross section showing one example of a cover tape of the invention for the electronic part conveyance. This cover tape for the electronic part conveyance comprises a substrate 1 having provided thereon a thermally adhesive resin layer 2, with an antistatic layer 3 being provided on the back side of the substrate 1. FIG. 2 is a schematic cross section showing another example of a cover sheet of the invention for the electronic part conveyance. In this cover tape for the electronic part conveyance, a base coating layer4 and an intermediate layer S are provided between the substrate 1 and the thermally adhesive resin layer 2 of the cover tape shown in FIG. 1.

As the substrate 1, any self-supporting one may be used. For example, there are illustrated paper; films or sheets of plastics such as polyolefin resins, e.g., polyethylene and polypropylene (e.g., high molecular weight polypropylene), polyesters such as polyethylene terephthalate, polybutylene terephthalate and polyethylene naphthalate, polycarbonates, sulfone-based resins such as polyphenylene sulfide and polyether sulfone, polyether ketone, nylon (polyamide), polyimide, styrenic resins such as polystyrene; and the like.

One side or both sides of the above-mentioned plastic films or sheets may be subjected to such treatment as an adhesion-imparting treatment or a discharge treatment, or they may be laminated with Japanese paper, condenser craft paper, manila paper, crepe paper, flat paper, hemp paper, glassine paper or a polyolefin such as polyethylene or polypropylene to be utilized as the substrate 1.

To the substrate 1 may be added, as needed, conventional additives such as an antioxidant, an ultraviolet ray absorbent, a softening agent, a rust inhibitor, inorganic particles, antistatic agent (e.g., quaternary ammonium salt, etc.), an electrically conductive metal powder, an organic electrically conductive high polymer agent, a titanium-based or silane-based coupling agent, etc.

The melting point of the substrate 1 is preferably 90° C. or more. In case when the melting point of the substrate 1 is less than 90° C., the substrate 1 may shrink or be molten upon taping of electronic parts, thus the state of taping becoming so unstable that there might occur falling or projection of the electronic part.

The substrate 1 may be of a single layer or a plurality of layers. The thickness of the substrate 1 is generally about 2 to about 250 μm, preferably about 20 to about 200 μm.

The cover tape of the invention for the electronic part conveyance has a high interlaminer strength due to the base coating layer 4 provided between the substrate 1 and the thermally adhesive resin layer 2 (or, in the case of providing an interlayer 5, between the substrate 1 and the interlayer 5). The base coating layer 4 is constituted by a known or conventional adhesive (an anchor coating agent) and is formed by a conventional coating method such as a method of coating on the substrate 1 an adhesive such as an urethane-based adhesive, an isocyanate-based adhesive, a polyester-based adhesive, an epoxy-based adhesive, an oxazoline-based adhesive or an organic adhesive for preventing electrostatic induction using a kiss roll coater or the like. The thickness of the base coating layer 4 is about 0.05 to about 30 μm. In the case of constituting the base coating layer 4 by the urethane-based adhesive, the thickness is preferably about 0.05 to 10 μm. In case when the thickness of the base coating layer 4 is too large, there results a cover tape having spoiled handling properties, and such thickness is disadvantageous in view of production cost as well.

Additionally, in the case where the substrate 1 and the thermally adhesive resin layer 2 can be laminated with a high adhesive strength, the base coating layer 4 is not necessarily provided.

Further, adhesion property between the substrate 1 and the thermally adhesive resin layer 2 can be enhanced by providing an interlayer 5. The interlayer 5 can be constituted by a thermoplastic resin such as a polyolefin resin, e.g., polyethylene (e.g., low density polyethylene, linear low density polyethylene, polyethylene produced by a metallocene catalyst process, middle density polyethylene, high density polyethylene, etc.); a thermoplastic elastomer; a rubber; etc. Particularly preferably, it is constituted by the polyolefin resin. The polymers for constituting the interlayer 5 may be used alone or in combination of two or more of them. The interlayer 5 can be formed by laminating the constituent polymer through a conventional method such as an extrusion laminating method, a co-extrusion method using a T-die tandem extrusion laminater or a dry laminating method.

The surface of the interlayer may be subjected, as needed, to a conventional surface treatment such as a corona discharge treatment or a plasma treatment to thereby improve surface activity. The thickness of the interlayer 5 may properly be selected from the range of not spoiling handling properties of resultant cover tapes, but is generally about 5 to about 30 μm.

Additionally, in the case where the substrate 1 and the thermally adhesive resin layer 2 can be laminated with a high adhesive strength, it is not necessary to provide the interlayer 5.

As a base polymer for constituting the thermally adhesive resin layer 2, there may be used at least one or more polymers selected from among olefin copolymers containing carboxyl groups or acyloxy groups within the molecule, an ionomer resin and a block copolymer between an aromatic vinyl compound and a conjugated diene compound. These polymers may be used independently or in combination of two or more of them.

Examples of the olefin copolymers containing carboxyl groups within the molecule include ethylene-unsaturated carboxylic acid copolymers such as ethylene-acrylic acid copolymer (EAA), ethylene-methacrylic acid copolymer (EMAA) and ethylene-maleic acid (or fumaric acid) copolymer; propylene-unsaturated carboxylic acid copolymers such as propylene-acrylic acid copolymer, propylene-methacrylic acid copolymer and propylene-maleic acid (or fumaric acid) copolymer; and ethylene-vinyl acetate-unsaturated carboxylic acid copolymer. These poylmers may be used independently or in combination of two or more of them.

In the olefin copolymers containing carboxyl groups within the molecule, the content of carboxyl group-containing monomer units (for example, the content of acrylic acid units in EAA) is, for example, 4 to 30% by weight, preferably 10 to 15% by weight. In case where the content is less than 4% by weight, reduction in adhesive property is liable to take place and, since crosslinking sites are small in number, heat resistance is liable to be deteriorated after curing. In case where the content exceeds 30% by weight, the stress relaxation properties tend to be deteriorated due to an increase in elastic modulus and, in addition, moisture absorption ratio of the thermally adhesive resin becomes large due to hygroscopic properties of carboxyl group, and the adsorbed moisture in turn causes a problem that peeling or formation of voids is liable to occur due to vapor pressure of vaporized moisture.

As the ethylene-acrylic acid copolymer (EAA), commercially available examples include “Novatec EAA” made by Nippon Polychem Co., Ltd.; and “Primacol” made by Dow Chemical Nippon K.K. and, as the ethylene-methacrylic acid copolymer (EMAA), commercial products such as “Nucrel” made by Mitsui Du-pont Polychemical Co., Ltd. are available.

Examples of the olefin copolymers containing acyloxy groups (e.g., acetoxy group) within the molecule include ethylene copolymers such as ethylene-vinyl acetate copolymer (EVA) and ethylene-ethylene diacetate copolymer; and propylene copolymers such as propylene-vinyl acetate copolymer and propylene-ethylene diacetate copolymer. In these copolymers, the content of the monomer units containing the acyloxy group (for example, the content of vinyl acetate in EVA) is, for example, 6 to 28% by weight, preferably 6 to 14% by weight. In case where the content is less than 6% by weight, there results a poor adhesive property whereas, in case where the content exceeds 28% by weight, there result film cracks upon filming or poor stability of adhesive property by adsorbed moisture due to an increase in hygroscopic properties.

As the ethylene-vinyl acetate (EVA) copolymer, “Mirason” containing 10% by weight or less vinyl acetate, made by Mitsui Chemicals Inc. and “Evaflex” made by Mitsui Du-Pont Polychemical Co., Ltd. are commercially available.

Examples of the ionomer resin include a resin wherein part of the carboxyl groups of the aforesaid ethylene-unsaturated carboxylic acid copolymer are crosslinked with a metal, etc. As the ionomer resin, “Himilan” made by Mitsui Du-Pont Polychemical Co., Ltd. is commercially available.

As the block copolymer between an aromatic vinyl compound and a conjugated diene compound, there is illustrated a block copolymer comprising a polymer segment of an aromatic vinyl compound such as polystyrene and a polymer segment of a conjugated diene compound such as polybutadiene or polyisoprene.

As the block copolymer between an aromatic vinyl compound and a conjugated diene compound, hydrogenated ones are preferred in view of thermal stability and, further, those prepared by adding maleic acid or the like to enhance compatibility with a polyolefin resin or reactivity with an epoxy resin are more preferred. As such block copolymers, “Taftec M series” made by Asahi Chemical Industry Co., Ltd. and “Crayton FG1901X” made by Shell Japan K.K. are commercially available.

As the base polymer constituting the thermally adhesive resin layer 2, the olefin copolymer and the block copolymer may be used in combination from the above-described polymers. As to proportion of the polymers, the proportion of the olefin copolymer/the block copolymer is 40/60 to 80/20 (by weight ratio), preferably 45/55 to 70/30 (by weight ratio). In case where the content of the olefin copolymer is less than 40% by weight, there results such a strong rubbery properties that workability of the resin is reduced and, as a result of reduction in the content of functional groups such as carboxyl group in the adhesive composition, adhesive property and heat resistance are also reduced. In case where the content of the olefin copolymer exceeds 80% by weight, it becomes difficult to form a heat-bondable resin layer having a good appearance.

To the thermally adhesive resin layer 2 are often added a tackifier resin, an antistatic agent and an electrically conductive material in addition to the above-mentioned base polymer. Examples of the tackifier resin include petroleum resin (e.g., aliphatic petroleum resin (C₅ series), aromatic petroleum resin (C₉ series), alicyclic petroleum resin obtained by hydrogenating the aromatic petroleum resin, etc.), rosin-based resin, phenol resin, alkylphenol resin, styrene-based resin and terpene-based resin (dipentene resin, α-pinene resin, β-pinene resin, terpenephenol resin, terpene resin obtained by hydrogenating the terpene resin). These tackifier resins may be used alone or in combination of two or more of them. Incorporation of the tackifier resin in the thermally adhesive resin layer 2 serves to improve taping workability and provide a wrapping base material such as a carrier tape with a stable and good adhesive force.

The softening temperature of the tackifier resin is preferably 50° C. or more. In case where the softening temperature is less than 50° C., the thermally adhesive resin layer may be liable to be softened during transportation or storage, which leads to adhesion or welding of electronic parts to the thermally adhesive resin layer to cause troubles upon incorporation in a circuit board.

The content of the tackifier resin is about 1 to about 100 parts by weight, preferably about 5 to about 50 parts by weight, per 100 parts by weight of the base polymer. In case where the content of the tackifer resin is less than 1 part by weight, there results such a low adhesive force that, after taping, the tape might possibly peel off to cause projection of the electronic part. Also, in case where the content of the tackifier exceeds 100 parts by weight, there results a serious variation in the peel strength—for example, there results such a high adhesive force that the tape is torn, or the thermally adhesive resin layer becomes so hard that there occurs the slipstick phenomenon (running) upon peeling to cause projection of the electronic part.

Examples of the antistatic agent include anionic surfactants such as alkylsulfates, alkylarylsulfates, etc.; cationic surfactants such as quaternary ammonium salts; nonionic surfactants such as glycerin monostearate; amphoteric surfactants such as betaines (e.g., dimethylalkylbetaine); and surfactants such as tertiary amines. Also, examples of the electrically conductive material include metal oxide, metal powder, carbon black, etc. The content of the antistatic agent and the electrically conductive material (total amount) is, for example, about 0.05 to about 50 parts by weight, preferably about 0.1 to about 10 parts by weight, per 100 parts by weight of the base polymer. In case where the content of the additives exceeds 50 parts by weight, the adhesive force is liable to decrease.

To the thermally adhesive layer 2 may further be added additives such as an inorganic filler (e.g., silica, alumina, aluminum hydroxide, magnesium hydroxide, etc.), an organic filler, a pigment, an aging inhibitor, a coupling agent (e.g., a silane-based coupling agent), etc. within a range of not deteriorating various properties of the cover tape. Additionally, as the inorganic filler, those which have been surface-treated with a silane coupling agent are preferred in view of compatibility with resins and improvement of adhesion. The contents of individual additives are, for example, about 0 to about 10 parts by weight (preferably about 0.01 to about 1 part by weight) per 100 parts by weight of the base polymer. In case where the content of the additives exceeds 10 parts by weight, the adhesive force is liable to decrease.

The thickness of the thermally adhesive resin layer 2 can properly be selected within the range of not spoiling adhesive property and handling properties but, in general, the thickness is generally about 1 to about 150 μm, preferably about 5 to about 50 μm.

In case where the thickness of the thermally adhesive resin layer 2 is less than 1 μm, there results a weak adhesive force whereas, in case where the thickness exceeds 150 μm, taping failure is liable to occur due to an increase in the total thickness of the tape and squeeze-out of the adhesive upon taping.

The surface of the thermally adhesive resin layer 2 may, if necessary, be subjected to a conventional surface treatment such as a corona discharge treatment or a plasma treatment.

The thermally adhesive resin layer 2 can be formed by melt-mixing the base polymer with, as needed, a tackifier resin, an antistatic agent, an electrically conductive material and other additive in a kneader or a continuous double-axis kneader, and laminating the resulting mixture (or pellets prepared therefrom) by a conventional method such as an extrusion method, a co-extrusion method using a T-die tandem extrusion laminater or a dry laminating method.

The antistatic layer 3 is constituted by a resin layer containing an antistatic agent, and is provided on the outer side of the substrate 1 or between the substrate 1 and the heat-bondable layer 2. As the antistatic agent, those which have been illustrated hereinbefore may be used. Examples of the resin for constituting the resin layer include olefin resins such as polyethylene and polypropylene; ethylenic binary copolymers such as ethylene-acrylic acid copolymer (EAA), ethylene-methacrylic acid copolymer (EMAA), ethylene-ethyl acrylate copolymer and ethylene-vinyl acetate copolymer (EVA); and ethylenic ternary copolymers such as ethylene-butyl acrylate-methacrylic acid copolymer.

The thickness of the antistatic layer 3 is, for example, about 0.005 to about 5 μm. The surface resistivity of the cover tape at both surfaces thereof can be controlled by adjusting the thickness within the above-mentioned range. In case where the thickness is less than 0.005 μm, there results a decreased antistatic effect and a high liability of interlaminer breakage of the laminate whereas, in case where the thickness exceeds 5 μm, there results a deteriorated transparency and a decreased adhesive property to the carrier tape, though the antistatic effect is enhanced. Thus, such thickness outside the range is not preferred.

The cover tape of the invention for the electronic part conveyance can be produced by, for example, subjecting at least one surface of a laminate comprising the substrate 1 having provided thereon the thermally adhesive resin layer with the antistatic layer 3 being provided on the outer side of the substrate 1 or between the substrate 1 and the thermally adhesive resin layer 2, to at least one treatment selected from among a moistening treatment using a moistening apparatus, a steam-spraying treatment and a treatment of spraying an aqueous antistatic agent.

As the aqueous antistatic agent, there are illustrated aqueous solutions or aqueous dispersions of water-soluble or water-dispersible surfactants among those which have been illustrated as the antistatic agents, specifically anionic surfactants such as sodium dodecylsulfate; cationic surfactants such as quaternary ammonium salts; nonionic surfactants such as polyoxyethylene alkyl ether; amphoteric surfactants such as betaine (e.g., dimethylalkylbetaine); and tertiary amines. Also, as the aqueous antistatic agent, there may be used an aqueous dispersion obtained by dispersing electrically conductive fine particles (electrically conductive material) such as fine particles of a metal oxide, metal powder or carbon black in water.

The above-described treatment is conducted on at least one side of the laminate having the substrate 1, the thermally adhesive resin layer 2 and the antistatic layer 3. The treatment may be conducted in combination with the aforesaid surface treatment. For example, the steam spray treatment or the treatment of spraying an aqueous antistatic agent may be conducted simultaneously with either the corona discharge treatment or the plasma treatment.

After the treatment, it is desirable to subject the laminate to a curing step and a drying step in order to fix the surfactant and the like on the surface of the adherend.

The cover tape of the invention for the electronic part conveyance is mainly characterized in that the contact angle to water at the surface of the thermally adhesive resin layer 2 is within the range of 0.5 to 95°, and that the surface resistivity is 1.0×10¹³ Ω/□ or less.

The contact angle to water at the surface of the thermally adhesive resin layer 2 can be controlled within a definite numeral range by properly selecting the composition of the resin constituting the thermally adhesive resin layer 2 and/or by properly selecting the spraying amount, spraying time and kinds of sprayed components upon conducting the above-described treatment such as the steam spray treatment on the surface of the thermally adhesive resin layer 2 after forming the laminate by providing the thermally adhesive resin layer 2 on the substrate 1 and providing the antistatic layer 3 on the outer side of the substrate 1 or between the substrate 1 and the thermally adhesive resin layer 2. Also, in the similar μmanner, the surface resistivity at the surface of the thermally adhesive resin layer 2 can be controlled to 1.0×10¹³ Ω/□ or less, particularly 10⁴ to 5×10¹² Ω/□, in an environment of 23° C. and 30% RH. Further, the critical surface tension γc can also be regulated within the range of 2.6×10⁻⁴ to 7.0×10⁻⁴ N/cm in the same manner as described above.

In addition to the above-described properties, the cover tape of the invention for the electronic part conveyance preferably has a contact angle to water of 0.5 to 70° at the opposite surface thereof to the thermally adhesive resin layer 2 and, further, the surface resistivities of the both surfaces of the cover tape is preferably 10×10¹³ Ω/□ or less.

The contact angle to water of the cover tape at the opposite surface thereof to the thermally adhesive resin layer 2 can be controlled within a definite numeral range by properly selecting the thickness of the antistatic layer 3 and/or by properly selecting the spraying amount, spraying time and kinds of sprayed components upon conducting the above-described treatment such as the steam spray treatment on the one or both surfaces of the laminate formed by providing the thermally adhesive resin layer 2 on the substrate 1 and providing the antistatic layer 3 on the outer side of the substrate 1 or between the substrate 1 and the thermally adhesive resin layer 2. Also, by properly employing a method for regulating characteristic properties of the surface or the opposite surface thereto of the thermally adhesive resin layer 2, the surface resistivity of the cover tape at the both surfaces thereof can be controlled to, for example, 1.0×10¹³ Ω/□ or less, preferably 10² Ω/□ to 10¹³ Ω/□, particularly preferably within the range of from 10⁴ Ω/□ to 5×10¹² Ω/□, in an environment of 23° C. and 30% RH.

Also, the cover tape of the invention for the electronic part conveyance has a light transmittance of preferably 80% or more. The light transmittance of the tape can be regulated by properly selecting the constituents or thickness of individual layers such as the substrate 1, the thermally adhesive resin layer 2 and the antistatic layer 3. In particular, in the process of the invention, a high transparency can be attained because antistatic properties are imparted by conducting one of the moistening treatment, the steam spray treatment and the treatment of spraying an aqueous antistatic agent.

The cover tape of the invention for the electronic part conveyance shows a peel strength after being applied on a paper mount and left for 30 days at 60 C and 90% RH of preferably about 0.1 to about 0.9 N (EIAJ standard), more preferably about 0.1 to about 0.7 N, particularly preferably about 0.1 to 0.3 N. This peel strength can be adjusted by, for example, properly selecting composition of the resin constituting the thermally adhesive resin layer 2.

The electronic part conveying member of the invention has an electronic part storage member adapted for storing an electronic part and a cover tape for covering the electronic part storage member and, as the cover tape, the cover tape of the invention for the electronic part conveyance is used.

As a typical example of such electronic part conveying member, there is illustrated a conveying member constituted by an embossed carrier tape wherein electronic part storage recess members for storing electronic parts are provided in a lengthwise direction at predetermined intervals at about the center in the transverse direction and a cover tape for the electronic part conveyance for covering the upper side of the electronic part storage recess members.

As the material for the embossed carrier tape, any of self-supporting ones may be used. For example, there may be used papers such as Japanese paper, crepe paper, synthetic paper, mixed paper and composite paper; films or sheets of plastics such as polyethylene, polypropylene, polyethylene terephthalate, polyvinyl chloride and cellophane; and metal foils.

Also, as another example of the electronic part conveying member of the invention, there is illustrated a conveying member comprising a square hole punch carrier tape having punched holes for storing electronic parts, a bottom cover tape for covering the bottom side of the square holes of the square hole punch carrier tape and a top cover tape for covering the top side of the square holes of the square hole punch carrier tape. In such conveying member, the cover tape of the invention for the electronic part conveyance is used as, for example, the top cover tape.

The cover tape for the electronic part conveyance and the electronic part conveying member of the invention can be suitably used for conveying a wide scope of chip-type electronic parts such as resistors, e.g., chip-fixed resistors, and condensers, e.g., laminate ceramic condensers.

With the cover tape of the invention for the electronic part conveyance, the surface properties such as contact angle to water and surface resistivity are regulated to be within definite numeral ranges, and hence it exhibits a good peeling properties permitting to prevent charging upon peeling and a suitable adhesive property and, in addition, it serves to reduce variation in the peel strength upon peeling. Also, a high transparency can be maintained, which serves to provide a good visibility of the electronic parts. Therefore, various troubles in a series of steps of from conveyance of electronic parts to incorporation thereof onto a circuit board can be prevented, thus reliability for parts and mounting reliability being markedly improved.

Also, the cover tape for the electronic part conveyance having the above-mentioned characteristics can be produced by the process of the invention of subjecting at least one surface of a laminate obtained by providing the thermally adhesive resin layer on the substrate and providing the antistatic layer on the outer side of the substrate or between the substrate and the thermally adhesive resin layer to the treatment such as the steam spray treatment, or of adjusting the thickness of the antistatic layer.

The invention is described more specifically by reference to Examples which, however, are not to be construed as limiting the invention. Additionally, in the following description, parts are by weight.

### EXAMPLE 1

100 parts of an ethylene-vinyl acetate copolymer (EVA; made by Mitsui DuPont Polychemical Co., Ltd.; trade name: “Evaflex P-1407”), 20 parts of an alicyclic hydrocarbon resin (made by Arakawa Chemical Industries, Ltd.; trade name: “Arkon P-100”) and 2 parts of glycerin monostearate (antistatic agent; made by Riken Vitamin Co., Ltd.; trade name: “S-100”) were kneaded in a kneader at 140 C for 20 minutes, then pelletized to obtain a thermally adhesive resin. An anchor coating agent (base coating layer; urethane-based adhesive) was coated on the surface of an antistatic layered polyester film (substrate having an antistatic layer; made by Toyobo K.K.; trade name: “E7415”) opposite to the antistatic layer-provided surface, followed by drying. A low density polyethylene (LD-PE; made by Mitsui Chemicals, Inc.; trade name: “Mirason 10P”) resin was melt-extruded on the anchor coat layer to provide an interlayer. Further, the pelletized thermally adhesive resin was melt-extruded thereon using an extrusion laminating machine to provide a thermally adhesive resin layer. Thus, there was obtained a laminate (total thickness: 60 μm) having a stratum structure of the antistatic layer (thickness: 0.1 μm)/the substrate (polyester film; thickness: 24.9 um)/the base coating layer (thickness: 0.5 μm)/ the interlayer (LD-PE; thickness: 15 μm)/ the thermally adhesive resin layer (EVA+alicyclic hydrocarbon resin+antistatic agent; thickness: 20 μm). Thereafter, the both surfaces of the laminate were subjected to the steam spraying treatment in a moistening machine and, after drying, the laminate was wound up to prepare a cover tape for the electronic part conveyance.

### EXAMPLE 2

30 parts of a styrenic block copolymer (made by Shell Kagaku K.K.; trade name: Kariflex TR1186”), 70 parts of an ethylene-vinyl acetate copolymer (made by Mitsui DuPont Polychemical Co., Ltd.; tradename: “Evaflex P-1407”), 20 parts of a terpenephenol resin (made by Arakawa Chemical Industries, Ltd.; trade name: “Tamanol 803”) and 0.5 part of an antistatic agent (made by Riken vitamin Co., Ltd.; trade name: “Rikemal SE-301”) were kneaded in a kneader at 140° C. for 20 minutes, then pelletized to obtain a thermally adhesive resin. An anchor coating agent (base coating layer; urethane-based adhesive) was coated on the surface of an antistatic layered polyester film (substrate having an antistatic layer; made by Toyobo K.K.; trade name: “E7415”) opposite to the antistatic layer-provided surface, followed by drying. A low density polyethylene (LD-PE; made by Asahi Chemical Industry Co., Ltd.; trade name: “L-1885”) resin was melt-extruded on the anchor coat layer to provide an interlayer. Further, the pelletized thermally adhesive resin was melt-extruded thereon using an extrusion laminating machine to provide a thermally adhesive resin layer. Thus, there was obtained a laminate (total thickness: 60 μm) having a stratum structure of the antistatic layer (thickness: 0.1 μm)/the substrate (polyester film; thickness: 24.9 um)/the base coating layer (thickness: 0.5 μm)/the interlayer (LD-PE; thickness: 15 μm)/ the thermally adhesive resin layer (styrenic block copolymer+EVA+terpenephenol resin+antistatic agent; thickness: 20 μm) Thereafter, the surface of the thermally adhesive resin layer of the laminate was subjected to an MSC treatment (Molecular Coating System; spraying through an ultra-high pressure nozzle, followed by hot air drying treatment at 70 to 80° C.) using as an antistatic agent a dimethylalkylbetaine (amphoteric surfactant; trade name: “SAT-4”); made by Nihon Junyaku K.K.), and the laminate was wound up to prepare a cover tape for the electronic part conveyance.

### COMPARATIVE EXAMPLE 1

A cover tape for the electronic part conveyance was prepared in the same manner as in Example 1 except for using an antistatic layer-free polyester film (substrate; made by Toray Co., Ltd.; trade name: “S-10”; thickness: 25 μm) in place of the antistatic layered polyester film (substrate having an antistatic layer; made by Toyobo K.K.; trade name: “E7415”) and not conducting the steam spraying treatment.

### COMPARATIVE EXAMPLE 2

A cover tape for the electronic part conveyance was prepared in the same manner as in Example 1 except for not conducting the steam spray treatment.

### COMPARATIVE EXAMPLE 3

A cover tape for the electronic part conveyance was prepared in the same manner as in Example 1 except for using an antistatic layer-free polyester film (substrate; made by Toray Co., Ltd.; trade name: “S-10”; thickness 25 μm) in place of the antistatic layered polyester film (substrate having an antistatic layer; made by Toyobo K.K.; trade name: “E7415”). Evaluation tests The following tests were conducted on the tapes obtained in Examples and Comparative Examples. The results are tabulated in Table 1.

(Contact Angle)

Contact angles to water of the tape at the side of the thermally adhesive resin layer and at the side of the antistatic layer were measured using an automatic contact angle meter (model CA-X; made by Kyowa Kaimen Kagaku K.K.).

(Surface Resistivity)

Surface resistivities of the tape at the side of the thermally adhesive resin layer and at the side of the antistatic layer were measured according to the test standard based on JIS K6911 using a microcurrent electrometer.

(Critical Surface Tension)

Critical surface tension γc at the surface of the thermally adhesive resin layer side was calculated based on the measured contact angle values.

(Peel Strength)

The thermally adhesive resin layer side of each of the tapes (width: 5.3 mm) obtained in Examples and Comparative Examples was placed on a paper mount, press-bonded for 0.2 second under the conditions of 180° C. in temperature and 0.25 MPa in pressure, and aged for 1 hour or longer at an ordinary temperature. The peel strength was measured under the conditions of 300 mm/minute in peeling rate and about 180 degrees in peeling angle using a tensilon testing machine.

Further, peel strength was measured after storing at 60° C. and 90% RH for 30 days from the press-bonding procedure.

(Light Transmittance)

The light transmittance of each tape was measured using a haze meter.

TABLE 1A

| | | Example | |
|---|---|---|---|
| | | 1 | 2 |
| Surface spraying treatment | | + | + |
| Surface of | Contact angle/water (°) | 75 | 20 |
| thermally | Surface resistivity (Ω/ [symbol] ) | 2.5 × 10¹⁰ | 6.5 × 10⁹ |
| adhesive | Critical surface tension | 3.5 | 3.9 |
| resin layer | (x10⁻⁴ N/cm) | | |
| Substrate | Contact angle/water (°) | 38 | 25 |
| side surface | Surface resistivity (Ω/ [symbol] ) | 3.5 × 10⁹ | 4.6 × 10¹⁰ |
| Peel | Room temperature (N) | 0.24 | 0.15 |
| strength/ | 60° C., after 30 days (N) | 0.2 | 0.1 |
| Paper mount | | | |

| | | |
|---|---|---|
| Light transmittance (%) | 86 | 90 |

TABLE 1B

| | | Comparative Example | | |
|---|---|---|---|---|
| | | 1 | 2 | 3 |
| Surface spraying treatment | | − | − | + |
| Surface of | Contact angle/water (°) | 98 | 102 | 97 |
| thermally | Surface resistivity (Ω/ | 10¹⁴ < | 10¹⁴ < | 8.5 × 10¹³ |
| adhesive | [symbol] ) | 2.5 | 2.5 | 2.4 |
| resin layer | Critical surface tension | | | |
| | (x10⁻⁴ N/cm) | | | |
| Substrate | Contact angle/water (°) | 68-79 | 56 | 68-71 |
| side | Surface resistivity (Ω/ | 1.6 × 10¹⁵ | 3.0 × 10¹³ | 1.9 × 10¹⁵ |
| surface | [symbol] ) | | | |
| Peel | Room temperature (N) | 0.30 | 0.25 | 0.23 |
| strength/ | 60° C., after 30 days | 1.02 | 1.10 | 1.20 |
| Paper mount | (N) | | | |

| | | | |
|---|---|---|---|
| Light transmittance (%) | 87 | 92 | 90 |

Each of the tapes of Examples 1 and 2 showed the contact angle to water and the surface resistivity within a suitable numeral range, and showed an excellent peel strength and an excellent light transmittance. On the other hand, each of the tapes of Comparative Examples 1 to 3 showed the contact angle to water and the surface resistivity outside the desirable numeral range, and showed a reduction in peel strength after storage.

This application is based on Japanese patent application JP 2001-387866, filed Dec. 20, 2001, the entire content of which is hereby incorporated by reference, the same as if set forth at length.

What is claimed is:

1. A cover tape for conveying an electronic part, which comprises:
a substrate;
a thermally adhesive resin layer; and
an antistatic layer provided one of: on the opposite side of the substrate to the thermally adhesive resin layer; and between the substrate and the thermally adhesive resin layer,
wherein the thermally adhesive resin layer has a surface having a contact angle to water of 0.5 to 95° and a surface resistivity of 1.0×10¹³ Ω/square or less.

2. The cover tape for the electronic part conveyance according to claim 1, wherein the surface of the thermally adhesive resin layer has a critical surface tension: γc of 2.6×10⁻⁴ to 7.0×10⁻⁴ N/cm.

3. The cover tape for the electronic part conveyance according to claim 1, which has a contact angle to water of 0.5 to 70° at the opposite surface to the thermally adhesive resin layer.

4. The cover tape for the electronic part conveyance according to claim 1 each side of which has a surface resitivity of 1.0×10¹³ Ω/square or less.

5. The cover tape for the electronic part conveyance according to claim 1, wherein the thermally adhesive resin layer comprises:
at least polymer selected from: an olefin copolymer containing a carboxyl group or an acyloxy group within the molecule; an ionomer resin; and a block copolymer of an aromatic vinyl compound and a conjugated diene compound;
an adhesion-imparting resin in an amount of 1 to 100 parts by weight per 100 parts by weight of the polymer; and
at least one of an antistatic agent and an electrically conductive material in a total amount of 0.05 to 50 parts by weight per 100 parts by weight of the polymer.

6. The cover tape for the electronic part conveyance according to claim 1, wherein the antistatic layer has a thickness of 0.005 to 5 μm.

7. The cover tape for the electronic part conveyance according to claim 1, wherein at least one surface of the cover tape has been subjected to at least one treatment selected from a moistening treatment, a steam spray treatment and a treatment of spraying with an aqueous antistatic agent.

8. The cover tape for the electronic part conveyance according to claim 1, wherein peel force of the cover tape after being left for 30 days in an environment of 60° C. and 90% RH in a state of being bonded to a paper mount is 0.1 to 0.9 N.

9. The cover tape for the electronic part conveyance according to claim 1, which has a light transmittance of 80% or more.

10. A process for producing a cover tape for conveying an electronic part, which comprising subjecting at least one surface of a laminate to at least one treatment selected from among a moistening treatment, a steam spray treatment and a treatment of spraying with an aqueous antistatic agent,
wherein the laminate comprises: a substrate; a thermally adhesive resin layer; and antistatic layer provided one of: on the opposite side of the substrate to the thermally adhesive resin layer; and between the substrate and the thermally adhesive resin layer.

11. An electronic part conveying member comprising: an electronic part storage member for storing an electronic part; and a cover tape for covering the electronic part storage member, wherein the cover tape for the electronic part conveyance according to claim 1 is used as the cover tape.
